(19) United States
(12) Patent Application Publication
(10) Pub. No.: US 2024/0033895 A1
(43) Pub. Date: Feb. 1, 2024

(54) ADJUSTABLE WORK PLATFORM

(71) Applicant: Travis Guttery, Fremont, CA (US)

(72) Inventor: Travis Guttery, Fremont, CA (US)

(21) Appl. No.: 17/877,034

(22) Filed: Jul. 29, 2022

(51) Int. Cl. B25H 1/02

(52) U.S. Cl. CPC B25H 1/02

(57) ABSTRACT

An adjustable work platform, including a main body to support at least one item disposed thereon, the main body including a first section, and a second section movably connected to at least a portion of the first section to move from retracted against the first section to at least partially extended away from the first section in a first lateral direction and move from extended away from the first section to retracted against the first section in a second lateral direction, a plurality of leg assemblies movably disposed on at least a portion of at least one of the first section and the second section to adjust a height of the first section and the second section with respect to a ground surface, and an adjustment knob movably disposed on at least a portion of the first section to prevent the second section from separating from the first section in response to rotating to a first position, and allow the second section to separate from the first section in response to rotating to a second position.

### BACKGROUND

### 1. Field

The present general inventive concept relates generally to a work bench, and particularly, to an adjustable work platform.

### 2. Description of the Related Art

Work benches are used for a wide variety of operations and projects whether in a private and/or a commercial setting. However, a common complaint amongst many workers is that a typical work bench lacks the ability to be adjusted. In particular, the typical work bench is either too short and/or too small for larger projects. As a result, the workers are forced to either purchase a new, larger work bench, and/or find other alternatives that can be incredibly inconvenient, insufficient, and/or time-consuming.

Therefore, there is a need for an adjustable work platform that can be adjusted for size as needed by the worker.

### SUMMARY

The present general inventive concept provides an adjustable work platform.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an adjustable work platform, including a main body to support at least one item disposed thereon, the main body including a first section, and a second section movably connected to at least a portion of the first section to move from retracted against the first section to at least partially extended away from the first section in a first lateral direction and move from extended away from the first section to retracted against the first section in a second lateral direction, a plurality of leg assemblies movably disposed on at least a portion of at least one of the first section and the second section to adjust a height of the first section and the second section with respect to a ground surface, and an adjustment knob movably disposed on at least a portion of the first section to prevent the second section from separating from the first section in response to rotating to a first position, and allow the second section to separate from the first section in response to rotating to a second position.

The main body may further include an extension leaf removably connected between the first section and the second section to prevent the second section from moving toward the first section while the extension leaf is connected therebetween.

The main body may further include a plurality of support brackets movably disposed on at least a portion of at least one of the first section and the second section to facilitate movement of at least one of the first section and the second section, and to receive the extension leaf thereon.

Each of the plurality of leg assemblies may include a leg body, a wheel movably disposed on at least a portion of the leg body to facilitate movement of the first section and the second section in response to an application of force against at least one of the first section and the second section, and a brake disposed on at least a portion of the leg body and connected to the wheel to prevent the wheel from moving in a locked position and allow the wheel to move in an unlocked position.

The leg body may move telescopically.

The leg body may be foldable.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top isometric view of an adjustable work platform, according to an exemplary embodiment of the present general inventive concept;

FIG. 2A illustrates a side perspective view of the adjustable work platform, according to an exemplary embodiment of the present general inventive concept; and

FIG. 2B illustrates a top perspective view of the adjustable work platform, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Adjustable Work Platform 100
Main Body 110
First Section 111
Second Section 112
Extension Leaf 113
Leaf Fasteners 113a
Support Brackets 114
Leg Assemblies 120
Leg Body 121
Wheel 122
Brake 123
Adjustment Knob 130

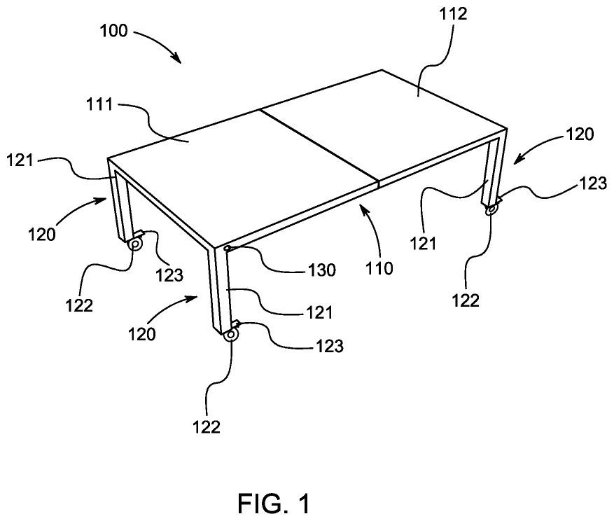

FIG. 1 illustrates a top isometric view of an adjustable work platform 100, according to an exemplary embodiment of the present general inventive concept.

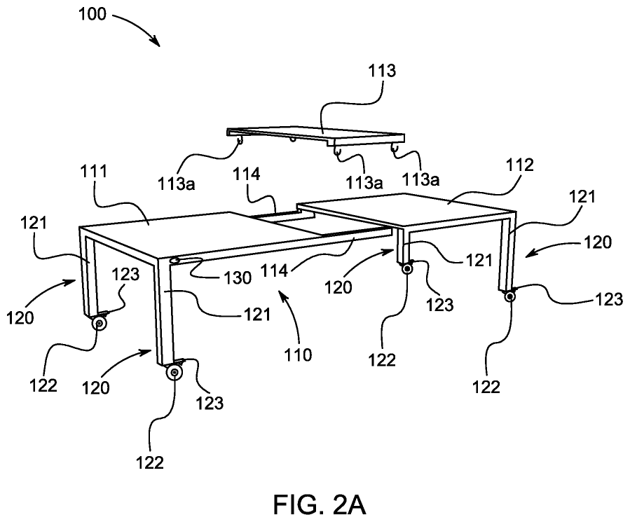

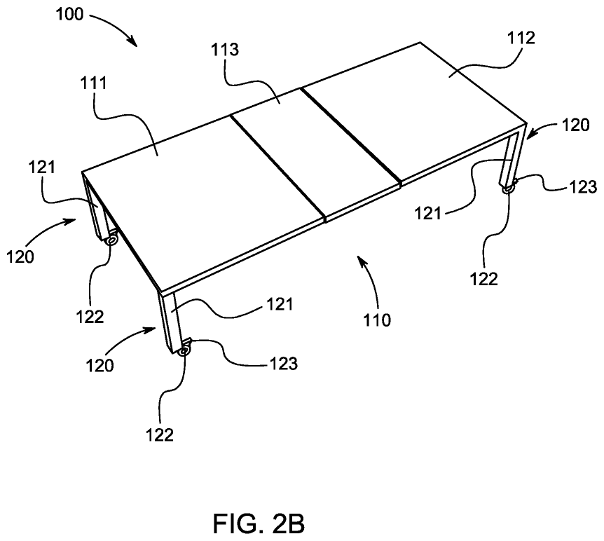

FIG. 2A illustrates a side perspective view of the adjustable work platform 100, according to an exemplary embodiment of the present general inventive concept.

FIG. 2B illustrates a top perspective view of the adjustable work platform 100, according to an exemplary embodiment of the present general inventive concept.

The adjustable work platform 100 may be constructed from at least one of metal, plastic, wood, and rubber, etc., but is not limited thereto.

The adjustable work platform 100 may include a main body 110, a plurality of leg assemblies 120, and an adjustment knob 130, but is not limited thereto.

Referring to FIGS. 1 through 2B, the main body 110 is illustrated to have a rectangular prism shape. However, the main body 110 may be rectangular, circular, cylindrical, triangular, pentagonal, hexagonal, heptagonal, octagonal, or any other shape known to one of ordinary skill in the art, but is not limited thereto.

The main body 110 may include a first section 111, a second section 112, an extension leaf 113, and a plurality of support brackets 114, but is not limited thereto.

The main body 110 may be a planar surface. Moreover, the main body 110 may support at least one item disposed thereon.

The first section 111 and/or the second section 112 may be half of a size (e.g., length, width, height) of the main body 110 in a first configuration. In other words, collectively, the first section 111 and/or the second section 112 may form an entirety of the first configuration of the main body 110. Moreover, the second section 112 may be movably connected to at least a portion of the first section 111. Additionally, the second section 112 may move (i.e., slide) from retracted against the first section 111 to at least partially extended away from the first section 111 in a first lateral direction or a second lateral direction. Conversely, the second section 112 may move from extended away from the first section 111 to retracted against the first section 111 in the second lateral direction or the first lateral direction.

The extension leaf 113 may be removably connected to at least a portion of the first section 111 and/or the second section 112. More specifically, the extension leaf 113 may be removably connected between the first section 111 and/or the second section 112 while the second section 112 is at least partially separated away from the first section 111. As such, the first section 111 and/or the second section 112 may be prevented from moving (e.g., retracting) while the extension leaf 113 is connected therebetween.

The extension leaf 113 may include a plurality of leaf fasteners 113a, but is not limited thereto.

Each of the plurality of leaf fasteners 113a may include a hook, a clasp, a clamp, a magnet, and/or any combination thereof, but is not limited thereto.

The plurality of support brackets 114 may be movably (i.e., slidably) disposed on at least a portion of the first section 111 and/or the second section 112. The plurality of support brackets 114 may facilitate movement of the first section 111 and/or the second section 112.

The plurality of leaf fasteners 113a may removably connect the extension leaf 113 to the first section 111 and/or the second section 112. More specifically, the plurality of fasteners 113a may hook onto each of the plurality of support brackets 114, such that the extension leaf 113 may be disposed on the plurality of support brackets 114. In other words, the plurality of support brackets 114 may receive the plurality of fasteners 113a thereon. As such, the extension leaf 113 may increase a total length of the main body 110 in a second configuration different from the first configuration. Thus, the extension leaf 113 may increase a surface area of the main body 110.

Each of the plurality of leg assemblies 120 may include a leg body 121, a wheel 122, and a brake 123, but is not limited thereto.

The leg body 121 may be movably disposed on at least a portion of the first section 111 and/or the second section 112. The leg body 121 may move telescopically and/or foldably. In other words, the leg body 121 may adjust a length based on a preference of a user. The leg body 121 may support the first section 111 and/or the second section 112 thereon. The leg body 121 may fold on at least a first portion and/or a second portion thereof. In other words, the leg body 121 may fold in half and/or at two portions (e.g., into thirds) thereof. As such, the leg body 121 may adjust a height of the first section 111 and/or the second section 112 with respect to a ground surface while the leg body 121 is disposed on the ground surface.

The wheel 122 may be movably (i.e., rotatably) disposed on at least a portion of an end of the leg body 121. The wheel 122 may facilitate movement of the first section 111, the second section 112, and/or the extension leaf 113 in response to an application of force (e.g., pushing, pulling) against the first section 111, the second section 112, and/or the extension leaf 113.

Also, the wheel 122 may be springingly (e.g., via a spring) disposed on the end of the leg body 121. The wheel 122 may move from extended outside of the leg body 121 to retracted within the leg body 121 in response to another application of force on the first section 111, the second section 112, and/or the extension leaf 113. Conversely, the wheel 122 may move from retracted within the leg body 121 to extended outside of the leg body 121 in absence of the another application of force on the first section 111, the second section 112, and/or the extension leaf 113. As such, the wheel 122 may move within the leg body 121 while a predetermined level of force is on the main body 110, such as a person standing on the main body 110, to increase stability of the main body 110 by preventing the wheel 122 from moving.

The brake 123 may be disposed on at least a portion of the end of the leg body 121 and/or connected to the wheel 122. The brake 123 may prevent the wheel 122 from moving in a locked position and allow the wheel 122 to move in an unlocked position.

The adjustment knob 130 may include a knob, a button, a lever, and a switch, but is not limited thereto.

The adjustment knob 130 may be movably (i.e., rotatably, springingly) disposed on at least a portion of the first section 111 and/or the second section 112. The adjustment knob 130 may be connected to movable hooks disposed on the first section 111 and/or the second section 112 to connect to each of the plurality of support brackets 114. Accordingly, the adjustment knob 130 may prevent the second section 112 from separating from the first section in response to rotating to a first position (i.e., hooked), and allow the second section 112 to separate from the first section in response to rotating to a second position (i.e., unhooked).

Therefore, the adjustable work platform 100 may adjust a size thereof based on the preference of the user. Also, the adjustable work platform 100 may be adjusted in length, surface area, and/or height.

The present general inventive concept may include an adjustable work platform 100, including a main body 110 to support at least one item disposed thereon, the main body 110 including a first section 111, and a second section 112 movably connected to at least a portion of the first section 111 to move from retracted against the first section 111 to at least partially extended away from the first section 111 in a first lateral direction and move from extended away from the first section 111 to retracted against the first section 111 in a second lateral direction, a plurality of leg assemblies 120 movably disposed on at least a portion of at least one of the first section 111 and the second section 112 to adjust a height of the first section 111 and the second section 112 with respect to a ground surface, and an adjustment knob 130 movably disposed on at least a portion of the first section 111 to prevent the second section 112 from separating from the first section 111 in response to rotating to a first position, and allow the second section 112 to separate from the first section 111 in response to rotating to a second position.

The main body 110 may further include an extension leaf 113 removably connected between the first section 111 and the second section 112 to prevent the second section 112 from moving toward the first section 111 while the extension leaf 113 is connected therebetween.

The main body 110 may further include a plurality of support brackets 114 movably disposed on at least a portion of at least one of the first section 111 and the second section 112 to facilitate movement of at least one of the first section 111 and the second section 112, and to receive the extension leaf 113 thereon.

Each of the plurality of leg assemblies 120 may include a leg body 121, a wheel 122 movably disposed on at least a portion of the leg body 121 to facilitate movement of the first section 111 and the second section 112 in response to an application of force against at least one of the first section 111 and the second section 112, and a brake 123 disposed on at least a portion of the leg body 121 and connected to the wheel 122 to prevent the wheel 122 from moving in a locked position and allow the wheel 122 to move in an unlocked position.

The leg body 121 may move telescopically.

The leg body 121 may be foldable.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An adjustable work platform, comprising:
a main body to support at least one item disposed thereon, the main body comprising:
a first section, and
a second section movably connected to at least a portion of the first section to move from retracted against the first section to at least partially extended away from the first section in a first lateral direction and move from extended away from the first section to retracted against the first section in a second lateral direction;
a plurality of leg assemblies movably disposed on at least a portion of at least one of the first section and the second section to adjust a height of the first section and the second section with respect to a ground surface; and
an adjustment knob movably disposed on at least a portion of the first section to prevent the second section from separating from the first section in response to rotating to a first position, and allow the second section to separate from the first section in response to rotating to a second position.

2. The adjustable work platform of claim 1, wherein the main body further comprises:
an extension leaf removably connected between the first section and the second section to prevent the second section from moving toward the first section while the extension leaf is connected therebetween.

3. The adjustable work platform of claim 2, wherein the main body further comprises:
a plurality of support brackets movably disposed on at least a portion of at least one of the first section and the second section to facilitate movement of at least one of the first section and the second section, and to receive the extension leaf thereon.

4. The adjustable work platform of claim 1, wherein each of the plurality of leg assemblies comprises:
a leg body;
a wheel movably disposed on at least a portion of the leg body to facilitate movement of the first section and the second section in response to an application of force against at least one of the first section and the second section; and
a brake disposed on at least a portion of the leg body and connected to the wheel to prevent the wheel from moving in a locked position and allow the wheel to move in an unlocked position.

5. The adjustable work platform of claim 4, wherein the leg body moves telescopically.

6. The adjustable work platform of claim 4, wherein the leg body is foldable.
